(19) United States
(12) Patent Application Publication
(10) Pub. No.: US 2008/0268724 A1
(43) Pub. Date: Oct. 30, 2008

(54) Elastic terminal structure

(75) Inventors: Kuang-Hua Shiu, Hukou Township (TW); Rui-Hong Huang, Hukou Township (TW); Qui-Da Xie, Hukou Township (TW); Qian-Hao Luo, Hukou Township (TW)

Correspondence Address: Troxell Law Office Pllc, Suite 1404, 5205 Leesburg Pike, Falls Church, VA, 22041, US

(73) Assignee: Singatron Enterprise Co., Ltd.

(21) Appl. No.: 11/790,296

(22) Filed: Apr. 24, 2007

(51) Int. Cl. H01R 13/46

(52) U.S. Cl. 439/892

(57) ABSTRACT

The present invention provides an improved elastic terminal structure, wherein an elastic terminal includes an extended portion, a soldering piece and elastic strips. Embedding members corresponding to a base extend from the extended portion of the elastic terminal, and the embedding members enable firmly clasping the elastic terminal within the base. Moreover, a plurality of the elastic strips extend inward from an inner side of the extended portion, an elastic member inwardly extends from each of the plurality of elastic strips, and an electrical conducting point inwardly extends from each of the plurality of elastic members. Elastic compression of the plurality of elastic members and disposition of the plurality of the electrical conducting points to ensure electrical conductivity between the conducting member and the elastic terminals when joined thereto, moreover, the manufacturing cost is reduced and elastic fatigue is postponed.

### BACKGROUND OF THE INVENTION

(a) Field of the Invention

The art of the present invention provides an improved elastic terminal structure, and more particularly to an elastic terminal structure that enables a conducting member, when being electrically connected, to effect elastic compression of a plurality of elastic members respectively extending from and configured on a plurality of elastic strips to achieve a tight electrical connection with a plurality of electrical conducting points and ensure electrical conducting effectiveness.

(b) Description of the Prior Art

Referring to FIG. 1, which shows a conventional conducting terminal A used to conduct electric power, the objective of which is achieved by joining the conducting terminal A to a power supply element, wherein during the manufacturing process, additional molding of a main body A1 of the conducting terminal A must be first implemented separately. Hence, the need for a separate molding operation consumes the cost of the manufacturing process, and the processing steps are finicky and troublesome. Furthermore, elastic fatigue easily occurs in the main body A1 after long usage, which results in electrical conducting points of the conducting terminals A being uneven, causing concern over poor electrical conduction with a power supply element.

Hence, the inventor of the present invention proposes to resolve and surmount existent technical difficulties to eliminate the aforementioned shortcomings of prior art.

### SUMMARY OF THE INVENTION

The art of the present invention provides an improved elastic terminal structure, and more particularly to an elastic terminal structure that enables a conducting member, when being electrically connected, to effect elastic compression of a plurality of elastic members respectively extending from and configured on a plurality of elastic strips to achieve a tight electrical connection with a plurality of electrical conducting points and ensure electrical conducting effectiveness, thereby enabling reducing the cost of the manufacturing process and minimizing the problem of elastic fatigue.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view of prior art.

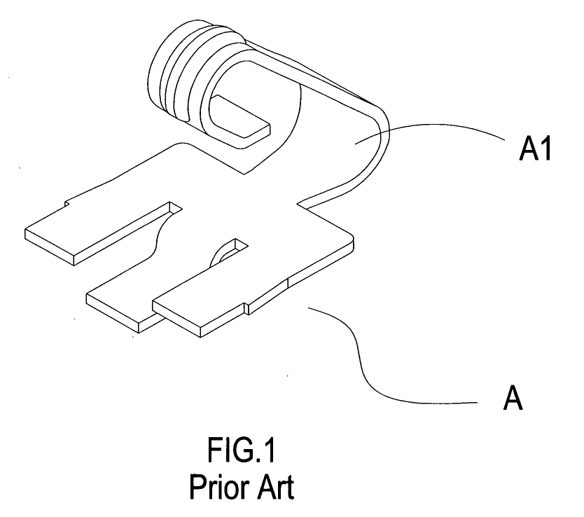

FIG. 2 shows an elevational view according to the present invention.

FIG. 3 shows a first elevational view of an embodiment according to the present invention.

FIG. 4 shows a second elevational view of the embodiment according to the present.

FIG. 5 shows a third elevational view of an embodiment according to the present.

FIG. 6 shows an elevational view of another embodiment according to the present.

### DETAILED DESCRIPTION OF THE PREFERRED EMBODIMENTS

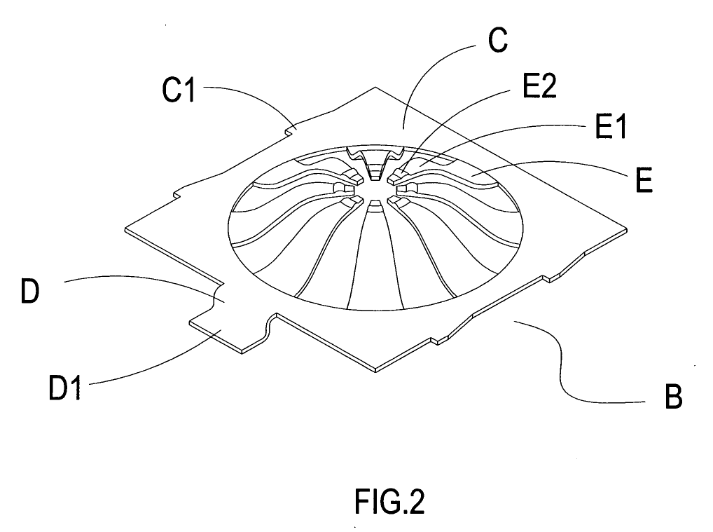

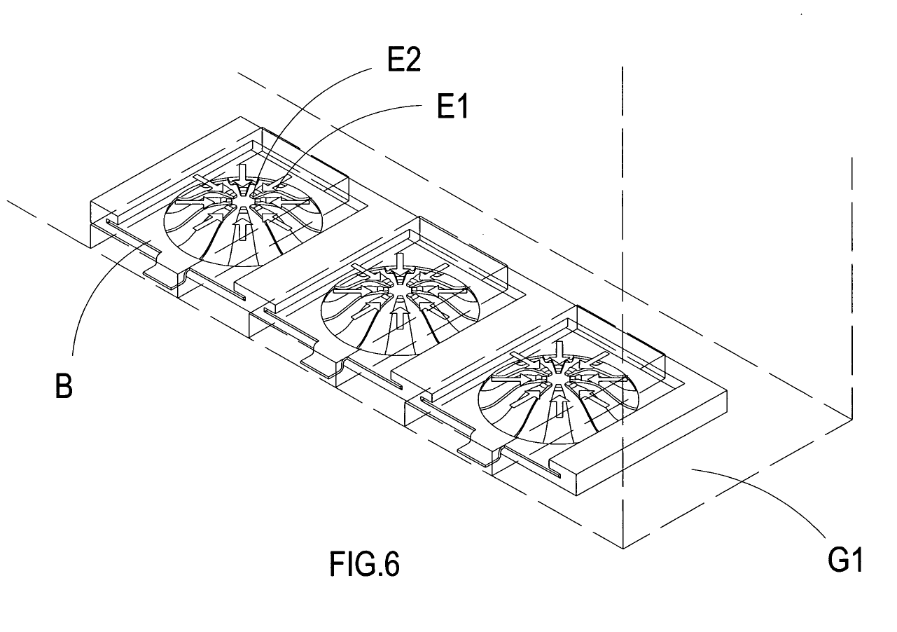

Referring to FIG. 2 and FIG. 6, which shows an improved elastic terminal structure of the present invention, wherein an elastic terminal B is structured to comprise an extended portion C, a soldering portion D and elastic strips E. Mutually corresponding embedding members C1 extend from a plane surface of the extended portion C, and a soldering portion D extends from one side of the extended portion C. A soldering piece D1 that enables electrical conduction extends from the soldering portion D, and the plurality of elastic strips E formed by press machining extend inward from an inner side of the extended portion C. Moreover, an elastic member E1 extends from each of the plurality of elastic strips E, and an electrical conducting point E2 that enables conducting of electric power extends from each of the plurality of elastic members E1. Elastic compression of the plurality of elastic members E1 and conducting effectiveness of the plurality of electrical conducting points E2 are used to enable the elastic terminal B to increase electrical conductivity of a conducting member G1 (as shown in FIG. 6), moreover, cost of the manufacturing process is reduced and the problem of elastic fatigue is minimized.

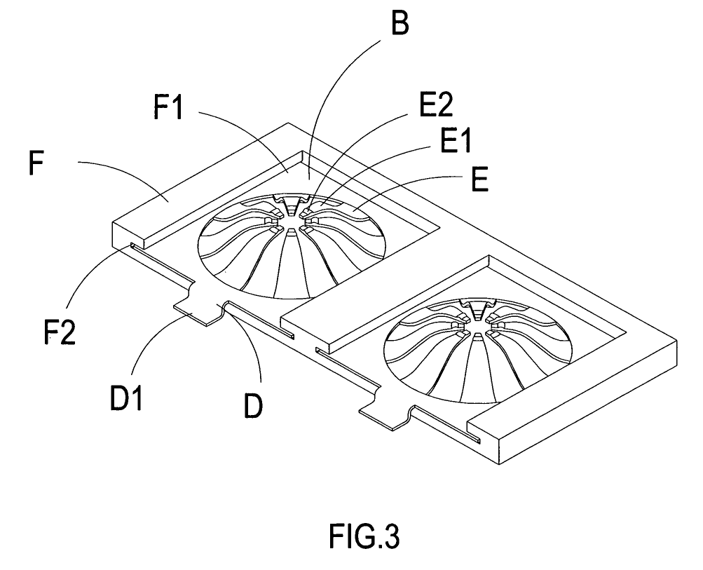

Referring to FIG. 2 and FIG. 3, which show an embodiment of the improved elastic terminal structure of the present invention, wherein the elastic terminals B are installed in a base F that is provided with functionality to enable electrical conductivity and embedding of the elastic terminals B. The base F is configured with one or more than one holding space F1, which enable the elastic terminals B to be disposed therein. Corresponding clasp slots F2 are respectively defined in the holding spaces F1, and when installing the elastic terminals B in the holding spaces F1, each of the clasp slots F2 fixedly clasp the mutually corresponding embedding members C1 extending from the extended portion C, thereby enabling the elastic terminals B to be fixedly disposed in the holding spaces F1 of the base F to achieve stable and firm embedding effectiveness. The plurality of elastic strips E formed by press machining extend inward from the inner side of the extended portion C, and the plurality of elastic members E1 are respectively press extended from the plurality of elastic strips E. Moreover, the plurality of electrical conducting points E2 that enable conducting of electric power respectively extend from the plurality of elastic members E1. Elastic compression of the elastic members E1 and the plurality of electrical conducting points E2 respectively extending from and configured on the elastic members E1 are used to enable improving electrical conducting effectiveness of the elastic terminal B, moreover, cost of the manufacturing process is reduced and elastic fatigue is prevented.

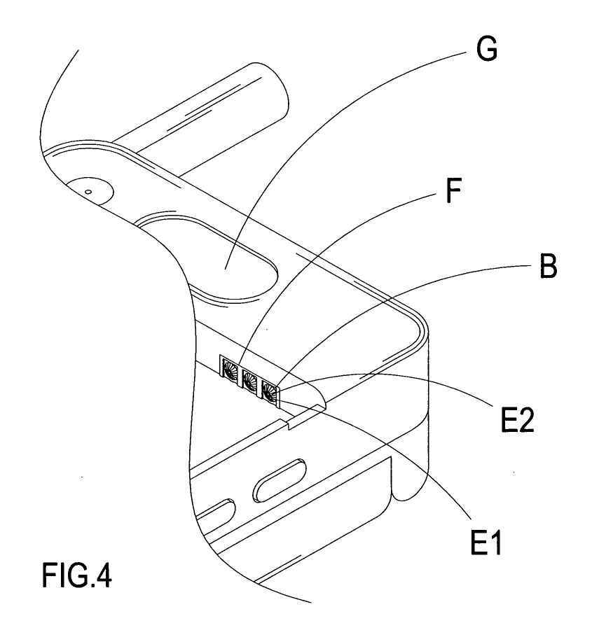

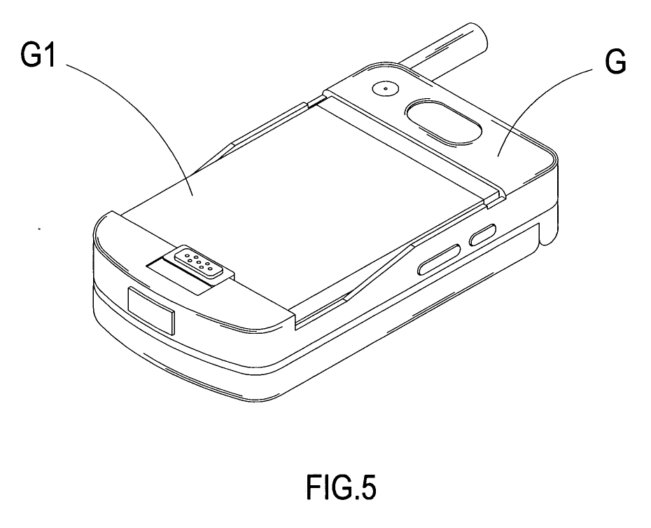

Referring to FIG. 4, FIG. 5 and FIG. 6, the base F installed with the elastic terminals B can be disposed in a cell phone case G, and with the elastic terminals B fixedly clasped in the base F, elastic compression of the elastic members E1 respectively extending from the elastic strips E and disposition of the plurality of the electrical conducting points E2 that enable conducting of electric power respectively extending from the elastic members E1 are used to enable the corresponding conducting member G1 of the cell phone case G to be tightly connected to the electrical conducting points E2. Moreover, when the conducting member G1 is connected to the plurality of electrical conducting points E2, press fitting of the conducting member G1 is used to effect elastic compression of the plurality of elastic members E1, thereby causing the plurality of electrical conducting points E2 to inwardly converge, which enables achieving effective conducting of electric power and improves electrical conducting effectiveness between the conducting member G1 and the plurality of electrical conducting points E2.

In order to better explicitly disclose advancement and practicability of the present invention, a comparison with prior art is described hereinafter:

### Shortcomings of Prior Art

1. Additional molding must be implemented separately, thus, cost of the manufacturing process is high.

2. Processing steps are finicky and troublesome.

3. Long usage causes elastic fatigue, which results in poor electrical conduction.

4. Only uses a single electrical conducting point, and thus unable to ensure electrical conducting effectiveness.

### ADVANTAGES OF THE PRESENT INVENTION

1. Eliminates the need to implement separate molding, and thus saves on the cost of the manufacturing process.

2. Simplifies the processing steps.

3. Application of the plurality of elastic strips E to connect to a conducting member reduces the probability of causing elastic fatigue.

4. Use of the plurality of electrical conducting points E2 to connect to a conducting member enables ensuring effective conducting of electric power.

5. Provided with advancement and practicability.

6. Enhances industrial competitiveness.

In conclusion, the present invention in overcoming structural shortcomings of prior art has assuredly achieved effectiveness of anticipated advancement, and, moreover, is easily understood by persons unfamiliar with related art. Furthermore, contents of the present invention have not been publicly disclosed prior to this application, and practicability and advancement of the present invention clearly comply with essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An elastic terminal structure, wherein an elastic terminal comprises an extended portion, from which extend a plurality of embedding members, a soldering portion extending from a side of the extended portion and a soldering piece that enables electrical conduction extending from the soldering portion; wherein a plurality of elastic strips extend inward from an inner side of the extended portion, an elastic member extends from each of the plurality of elastic strips, and an electrical conducting point that enables conducting of electric power extends from each of the plurality of elastic members; whereby a conducting member uses elastic compression of the plurality of elastic members to connect to the plurality of electrical conducting points, thereby enabling the elastic terminal to increase electrical conductivity of the conducting member, moreover, the cost of the manufacturing process is reduced and the problem of elastic fatigue is minimized.

2. The elastic terminal structure according to claim 1, wherein the elastic terminals are installed in a base that is provided with functionality to embed the elastic terminals and electrical conductivity, and the embedding members of the elastic terminals function in coordination with clasp slots of the base to enable connecting therewith and achieve normal conducting effectiveness.

3. The elastic terminal structure according to claim 1, wherein the elastic strips are machine extruded from a plane surface of the extended portion and extend inward from an inner side of the extended portion forming the plurality of electrical conducting points having improved electrical conductivity, thereby reducing machine processing time and saving on molding costs.

4. The elastic terminal structure according to claim 1, wherein when a conducting member is connected to the plurality of electrical conducting points, press fitting of the conducting member is used to effect elastic compression of the plurality of elastic members, thereby causing the plurality of electrical conducting points to inwardly converge and achieve improving electrical conducting effectiveness of the conducting member.
